(19) United States
(12) Patent Application Publication
(10) Pub. No.: US 2020/0070545 A1
(43) Pub. Date: Mar. 5, 2020

(54) INK JET METHOD AND RECORDING APPARATUS

(71) Applicant: Seiko Epson Corporation, Tokyo (JP)

(72) Inventors: Keitaro NAKANO, Matsumoto (JP); Tsuyoshi SANO, Shiojiri (JP); Toru SAITO, Yamagata (JP)

(21) Appl. No.: 16/556,456

(22) Filed: Aug. 30, 2019

(30) Foreign Application Priority Data
Aug. 31, 2018 (JP) 2018-162548

(51) Int. Cl. B41J 11/00; B41J 2/21

(52) U.S. Cl. CPC B41J 11/002; B41J 2/21

(57) ABSTRACT

Provided is an ink jet method including a step of ejecting a first composition from an ink jet head, the first composition being a radiation-curable composition having a hue angle of −50° to −5°, a step of ejecting a second composition from an ink jet head, the second composition being a radiation-curable composition having a hue angle of 5° to 50°, and an exposure step of curing the ejected first composition and the ejected second composition by exposing the ejected first composition to radiation within 1 second after landing of the ejected first composition and exposing the ejected second composition to radiation within 1 second after landing of the ejected second composition.

The present application is based on, and claims priority from JP Application Serial Number 2018-162548, filed Aug. 31, 2018, the disclosure of which is hereby incorporated by reference herein in its entirety.

### BACKGROUND

### 1. Technical Field

The present disclosure relates to an ink jet method and a recording apparatus.

### 2. Related Art

Ink jet recording methods enable recording high-definition images by a relatively simple apparatus, and thus are rapidly developed in various fields. For example, JP-A-2006-348200 discloses an active energy ray-curable ink-jet ink containing a polymer dispersing agent, a monomer, a diketopyrrolopyrrole pigment, and a pigment derivative represented by a specific general formula, which is excellent in pigment dispersibility, ejection stability, and storage stability.

However, it has been found that there is a room for improvement in the balance between the color reproduction range and bleed of the ink composition described in JP-A-2006-348200.

### SUMMARY

The present inventors have carried out intensive studies to solve the problem described above. As a result, the present inventors have found that the problem described above can be solved by using two kinds of ink compositions having predetermined hue angles under predetermined conditions, and thus completed the present disclosure.

An ink jet method according to the present disclosure includes a step of ejecting a first composition from an ink jet head, the first composition being a radiation-curable composition having a hue angle of −50° to −5°, a step of ejecting a second composition from an ink jet head, the second composition being a radiation-curable composition having a hue angle of 5° to 50°, and a step of curing the ejected compositions by exposing the ejected compositions to radiation before 1 second elapses after landing of the respective ejected compositions.

The configuration of the present disclosure can be further set as follows:

[1] an ink jet method including a step of ejecting a first composition from an ink jet head, the first composition being a radiation-curable composition having a hue angle of −50° to −5°, a step of ejecting a second composition from an ink jet head, the second composition being a radiation-curable composition having a hue angle of 5° to 50°, and an exposure step of curing the ejected first composition and the ejected second composition by exposing the ejected first composition to radiation within 1 second after landing of the ejected first composition and exposing the ejected second composition to radiation within 1 second after landing of the ejected second composition;
[2] the ink jet method according to [1], further including a step of ejecting a radiation-curable cyan composition from an ink jet head, and a step of ejecting a radiation-curable yellow composition from an ink jet head;
[3] the ink jet method according to [1] or [2], wherein a difference between the hue angle of the first composition and the hue angle of the second composition is 10° to 35°;
[4] the ink jet method according to any one of [1] to [3], wherein the hue angle of the first composition is −30° to −10° and the hue angle of the second composition is 10° to 40°;
[5] the ink jet method according to any one of [1] to [4], wherein the first composition contains, as a pigment, one or more selected from the group consisting of P.R. 31, 122, 202, 207, 209, 147, and 269, and P.V. 32 and 19, and the second composition contains, as a pigment, one or more selected from the group consisting of P.R. 166, 168, 149, 177, 179, 254, 255, 264, 242, and 224;
[6] the ink jet method according to any one of [2] to [5], further including a step of ejecting a third composition from an ink jet head, the third composition being a radiation-curable composition having a hue angle larger than the hue angle of the second composition and smaller than a hue angle of the yellow composition;
[7] the ink jet method according to any one of [1] to [6], wherein irradiation energy of radiation in the exposure step is 5 mJ/cm² to 2000 mJ/cm²;
[8] the ink jet method according to any one of [1] to [7], wherein irradiation peak intensity of radiation in the exposure step is 150 mW/cm² or more;
[9] the ink jet method according to any one of [1] to [8], wherein an LED is used as a radiation source of radiation in the exposure step;
[10] the ink jet method according to any one of [1] to [9], further including, after the exposure step, further exposing each composition to radiation after elapse of 1 second after landing of each composition;
[11] the ink jet method according to any one of [1] to [10], wherein the first composition and the second composition contain 2-(2-vinyloxyethoxy)ethyl acrylate;
[12] the ink jet method according to any one of [1] to [11], wherein a content of pigment in the first composition is 2% by mass or less with respect to a total amount of the first composition, and a content of pigment in the second composition is 2% by mass or less with respect to a total amount of the second composition;
[13] the ink jet method according to any one of [1] to [12], further including a step of ejecting a radiation-curable clear composition from an ink jet head; and
[14] an ink jet apparatus that performs the ink jet method according to any one of [1] to [13] and includes an ink jet head and a radiation source.

### BRIEF DESCRIPTION OF THE DRAWINGS

FIG. 1 is a schematic section view of a line printer illustrating a configuration thereof.

FIG. 2 is a perspective view of a serial printer illustrating a configuration thereof.

FIG. 3 is a schematic diagram schematically illustrating a recording system used in an example.

FIG. 4 is a schematic diagram schematically illustrating a recording system used in an example.

FIG. 5 is a schematic diagram schematically illustrating a recording system used in an example.

FIG. 6 is a schematic diagram schematically illustrating a recording system used in an example.

FIG. 7 is a schematic diagram schematically illustrating a recording system used in an example.

FIG. 8 is a schematic diagram schematically illustrating a recording system used in an example.

### DESCRIPTION OF EXEMPLARY EMBODIMENTS

Although an embodiment of the present disclosure (hereinafter referred to as the “present embodiment”) will be described in detail with reference to drawings as necessary, the present disclosure is not limited to this, and can be modified in various manners within the gist thereof. To be noted, the same elements will be denoted by the same reference signs in the drawings, and redundant description will be omitted. In addition, vertical and horizontal positional relationships are based on positional relationships illustrated in the drawings unless described otherwise. Further, the dimensional ratios of the drawings are not limited to illustrated ratios.

### Ink Jet Method

An ink jet method according to the present embodiment includes a step of ejecting a first composition from an ink jet head, the first composition being a radiation-curable composition having a hue angle of −50° to −5°, a step of ejecting a second composition from an ink jet head, the second composition being a radiation-curable composition having a hue angle of 5° to 50°, and a step of curing the ejected compositions by exposing the ejected compositions to radiation before 1 second elapses after landing of the respective ejected compositions.

Color regions of warm colors are widely used in signature and label printing, and it has come to be known that the color reproduction range of color regions of warm colors is relatively narrow. In addition, for colors of this kind, color difference tends to be visually easily recognized from slight color difference in recorded products, and the color reproduction range being wider is more advantageous for printing a desired color because this leads to higher color reproducibility. Radiation-curable compositions are relatively immediately exposed to radiation for curing from the viewpoint of suppressing bleed. However, it has come to be known that, according to such a method, the composition having landed cures before spreading on a recording medium, and therefore the color developability is degraded and the color reproduction range becomes narrower. In contrast, according to the present embodiment, by using a first composition which is a radiation-curing composition having a hue angle of −50° to −5° and a second composition which is a radiation-curing composition having a hue angle of 5° to 50° in combination, suppressing the bleed and securing the color reproduction range can be both achieved in a recording method of performing curing by relatively immediate exposure to radiation.

Steps of the recording method of the present embodiment will be described below. The recording method can be used for both of a line printer including a line head and a serial printer including a serial head. In the line system including a line head, an image can be recorded on a recording medium by fixing the head, moving the recording medium along a sub-scanning direction (the longitudinal direction of the recording medium, or a transport direction), and ejecting a composition through a nozzle opening of the head in synchronization with this movement. In addition, in the serial system including a serial head, an image can be recorded on a recording medium by moving the head along a main scanning direction (the transverse direction of the recording medium, or a width direction) and ejecting a composition through a nozzle opening of the head in synchronization with this movement.

To be noted, in the line system and the serial system, the ink jet head is a head that performs recording by ejecting each composition toward a recording medium, and the head includes cavities from which respective compositions accommodated therein are ejected through nozzles, an ejection driving unit that imparts driving force for ejection to the ink compositions, and nozzles through which respective compositions are ejected to the outside of the head. Normally, each composition fills each nozzle row, and the nozzle row ejects the same composition. However, the configuration is not limited to this. The ejection driving unit can be formed by using an electro-mechanical conversion element such as a piezoelectric element that changes the capacity of the cavities by mechanical deformation, a thermoelectric conversion element that causes ejection by generating heat to generate bubbles in the composition, or the like.

The ink jet method is a method of ejecting a composition by an ink jet system. Examples of the ink jet method include a recording method of producing a recorded product by attaching the ejected composition to a recording medium and a modeling method of producing a modeled article formed from the composition by layering the ejected composition.

### First Composition Ejection Step

This step is a step of ejecting a first composition which is a radiation-curable composition having a hue angle of −50° to −5° toward a recording medium from an ink jet head. The first composition used in this step is a composition corresponding to a magenta ink, and colors of all hue angles can be reproduced in a good balance by combining the magenta ink with yellow and cyan inks. From this viewpoint, the first composition has a hue angle smaller than 0°.

### First Composition

The hue angle of the first composition is −50° to −5°, and may be −30° to −10°, −25° to −13°, or −20° to −15°. When the hue angle of the first composition is in the range described above, the color reproduction range tends to be improved.

The composition of the first composition is not particularly limited as long as the first composition is a radiation-curable composition having a hue angle of −50° to −5°, and for example, the first composition contains a pigment, a polymerizable compound, a polymerization initiator, a dispersing agent, and if necessary, a polymerization inhibitor, a surfactant, and other additives. Each component will be described below.

A radiation-curable composition is a composition that is cured by being exposed to radiation. Examples of the radiation include ultraviolet light, visible light, and electron beams.

An ink jet composition is a composition that is ejected from an ink jet head by an ink jet system.

### Pigment

The hue angle of the first composition is determined by the pigment. The pigment contained in the first composition may be one or more selected from the group consisting of P.R. 31, 122, 202, 207, 209, 147, and 269, and P.V. 32 and 19, and may be P.R. 122 among these. By using such pigment, the color reproduction range can be improved more, and thus a composition having a desired hue angle can be easily prepared. Further, the cured product of the first composition forms a coating film so as to coat the pigment, and therefore there is a tendency that the light resistance of the pigment is improved as compared with the light resistance the pigment originally has. In addition, a combination of two or more kinds of pigments that make the hue angle of the first composition −50° to −5° may be selected. In this view, the hue angle of each individual pigment is not limited to −50° to −5°.

To be noted, in the present embodiment, the hue angle is obtained from a value obtained by color measurement of a recorded product produced by performing recording by using the composition, the color measurement conforming to CIELAB. However, the hue angle of the first composition is displayed in a range from −90° to 0°. The position of the angle of the range of −90° to 0° in the a*b* plane is the same as that of a case where the angle is displayed in a range of 270° to 360° by adding 360° to the angle.

The hue angle of the second composition is displayed in a range from 0° to 90°. The hue angles of the other compositions are displayed in a range of 0° or more and less than 360°.

The hue angles of the first composition and the second composition of the present embodiment are hue angles in the case where a* is 60. These compositions are injected into the ink jet recording apparatus, and are attached to a recording material. Then, a color measurement pattern is generated by curing the compositions by radiating ultraviolet light having an irradiation energy of 500 mJ/cm² and a peak intensity of 1000 mW/cm² thereto from a light emitting diode (LED) having a peak wavelength of 395 nm as a light source. To be noted, the color measurement pattern generated at this time is generated to include a plurality of recording patterns having different attachment amounts by gradually changing the amount of attachment of the composition from a small amount to a large amount by a predetermined increment. For example, the patterns are generated by increasing the attachment amount by an increment of 0.1 mg/inch². The predetermined increment of the attachment amount may be increased or reduced from this value such that a correct hue angle can be achieved in the case where a* is 60.

Color measurement of the color measurement pattern was performed in conditions of a light source of D50, a field angle of 2°, a white standard of absolute white, and no light source filter by using a spectrometer conforming to CIELAB. In the color measurement pattern, a region where a* of color measurement value is 60 or more and the amount of attachment of the composition is the smallest is specified, and the hue angle of that region is measured.

To be noted, the hue angles of other compositions than the first composition and the second composition are hue angles obtained at the same attachment amount as the attachment amount of the first composition at which the hue angle of the first composition is calculated.

The hue angles are calculated from the measured values of a* and b* in accordance with CIELAB. The calculation formula is as follows.

h=tan⁻¹(b*/a*)

360° may be added to or subtracted from the hue angle for each composition such that the hue angle is within the range described above.

The content of the pigment may be 7.5% by mass or less, 5% by mass or less, 3% by mass or less, or 2% by mass or less with respect to the total amount of the first composition. In addition, the content of the pigment may be 0.1% by mass or more, 0.5% by mass or more, or 1% by mass or more with respect to the total amount of the first composition. When the content of the pigment is within the range described above, the optical density of the obtained recorded product and the dispersion stability of the composition tend to be improved. Particularly, since the cured product of the first composition forms a coating film that coats the pigment and the pigment becomes less likely to sediment at the bottom of the coating film, high color developability can be achieved with a relatively small amount of pigment.

### Polymerizable Compound

The polymerizable compound polymerizes as an action of the polymerization initiator that will be described later, and the composition cures as a result. As such a polymerizable compound, various monomers and oligomers such as monofunctional, bifunctional, and multifunctional monomers and oligomers that have three or more functional groups that are known can be used. Examples of the monomers described above include unsaturated carboxylic acids such as (meth)acrylic acid, itaconic acid, crotonic acid, isocrotonic acid, and maleic acid and salts, esters, urethanes, amides, and anhydrides thereof, acrylonitrile, styrene, various unsaturated polyesters, unsaturated polyethers, unsaturated polyamides, and unsaturated urethanes. In addition, examples of the oligomers described above include oligomers formed from the monomers described above such as straight chain acrylic oligomers, epoxy (meth)acrylate, oxetane (meth) acrylate, aliphatic urethane (meth)acrylate, aromatic urethane (meth)acrylate, and polyester (meth) acrylate.

Among the polymerizable compounds described above, esters of (meth)acrylic acid may be selected. More specifically, examples of monofunctional (meth)acrylates include monofunctional (meth)acrylates having an aromatic ring skeleton such as isoamyl (meth)acrylate, stearyl (meth)acrylate, lauryl (meth)acrylate, octyl (meth)acrylate, decyl (meth)acrylate, isomyristyl (meth)acrylate, isostearyl (meth) acrylate, 2-ethylhexyl-diglycol (meth) acrylate, 2-hydroxybutyl (meth) acrylate, butoxyethyl (meth) acrylate, ethoxydiethylene glycol (meth)acrylate, methoxydiethylene glycol (meth)acrylate, methoxypolyethylene glycol (meth)acrylate, methoxypropylene glycol (meth)acrylate, tetrahydrofurfuryl (meth) acrylate, isobonyl (meth) acrylate, 2-hydroxyethyl (meth) acrylate, 2-hydroxypropyl (meth)acrylate, lactone-modified flexible (meth)acrylate, t-butylcyclohexyl (meth) acrylate, dicyclopentanyl (meth) acrylate, dicyclopentenyloxyethyl (meth) acrylate, phenoxyethyl (meth) acrylate, phenoxydiethylene glycol (meth)acrylate, 2-hydroxy-3-phenoxypropyl (meth)acrylate, and benzyl (meth)acrylate, and (meth)acrylic acid esters including a vinyl ether group.

Among the (meth)acrylates described above, examples of the bifunctional (meth)acrylates include diethylene glycol di(meth)acrylate, triethylene glycol di(meth)acrylate, tetraethylene glycol di(meth)acrylate, polyethylene glycol di(meth)acrylate, dipropylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, ethylene oxide (EO) adduct di(meth)acrylate of bisphenol A, propylene oxide (PO) adduct di(meth)acrylate of bisphenol A, neopentyl glycol hydroxypivalate di(meth)acrylate, and polytetramethylene glycol di(meth)acrylate. Among these, at least one of diethylene glycol di(meth)acrylate and propylene glycol di(meth)acrylate may be selected.

Among the (meth)acrylates described above, examples of the multifunctional (meth)acrylates having three or more functional groups include trimethylolpropane tri(meth)acrylate, EO-modified trimethylolpropane tri(meth)acrylate, pentaerythritol tri(meth)acrylate, pentaerythritol tetra(meth)acrylate, dipentaerythritol hexa(meth)acrylate, ditrimethylolpropane tetra(meth)acrylate, glyceryl propoxy tri(meth)acrylate, caprolactone-modified trimethylolpropane tri(meth)acrylate, pentaerythritolethoxy tetra(meth)acrylate, and caprolactam-modified dipentaerythritol hexa(meth)acrylate.

Among these, phenoxyethyl (meth)acrylate, vinyl ether group-containing (meth)acrylic acid ester, and dipropylene glycol di(meth)acrylate may be selected to improve the curability and decrease the viscosity of the ink. Particularly, from the viewpoint of curability and low viscosity, the first composition and the second composition may contain 2-(2-vinyloxyethoxy)ethyl acrylate as the vinyl ether group-containing (meth)acrylic acid ester. To be noted, vinyl ether-containing (meth)acrylic acid ester is a compound represented by the general formula (I) below.

CH₂═CR¹—COOR²—O—CH═CH—R³ (I)

In the formula (I) shown above, R¹ represents a hydrogen atom or a methyl group, R² represents a divalent organic residue having 2 to 20 carbon atoms, and R³ represents a hydrogen atom or a monovalent organic residue having 1 to 11 carbon atoms. Examples of the divalent organic residue having 2 to 20 carbon atoms represented by R² include linear, branched, or cyclic substitutable alkylene groups having 2 to 20 carbon atoms, substitutable alkylene groups having 2 to 20 carbon atoms and an oxygen atom of an ether bond and/or an ester bond in the structure thereof, and substitutable divalent aromatic groups having 6 to 11 carbon atoms. Among these, alkylene groups having 2 to 6 carbon atoms such as an ethylene group, an n-propylene group, an isopropylene group, and a butylene group, and alkylene groups having 2 to 9 carbon atoms and an oxygen atom of an ether bond in the structures thereof such as an oxyethylene group, an oxy-n-propylene group, an oxyisopropylene group, and oxybutylene group may be used. In addition, examples of the monovalent organic residue having 1 to 11 carbon atoms represented by R³ include linear, branched, or cyclic substitutable alkyl groups having 1 to 10 carbon atoms and substitutable aromatic groups having 6 to 11 carbon atoms. Among these, alkyl groups having 1 or 2 carbon atoms, which are a methyl group and an ethyl group, and aromatic groups having 6 to 8 carbon atoms such as a phenyl group and a benzyl group may be used.

When each organic residue described above is a substitutable group, the substitute thereof can be divided into groups having a carbon atom and groups not having a carbon atom. First, in the case where the substitute is a group having a carbon atom, the carbon atom is counted in the number of carbon atoms of the organic residue. Examples of the group having a carbon atom include, but are not limited to, a carboxyl group and an alkoxy group. Next, examples of the group not having a carbon atom include, but are not limited to, a hydroxyl group and a halo group.

The content of the 2-(2-vinyloxyethoxy)ethyl acrylate may be 35% by mass or less, or 30% by mass or less with respect to the total amount of the first composition. As a result of the content of the 2-(2-vinyloxyethoxy)ethyl acrylate being within the range described above, the effect of curability and low viscosity can be achieved.

In addition, an N-vinyl compound may be contained as the polymerizable compound. Examples of the N-vinyl compound include N-vinylformamide, N-vinylcarbazole, N-vinylacetamide, N-vinylpyrrolidone, N-vinylcaprolactam, acryloylmorpholine, and derivatives of these.

The polymerizable compounds described above may be used alone or in combination of two or more kinds.

The content of the polymerizable compound may be 60 to 98% by mass, 70 to 95% by mass, or 80 to 92% by mass with respect to the total amount of the composition. When the content of the polymerizable compound is within the range described above, there is a tendency that the curability is improved, the bleed of the obtained recorded product is suppressed, and the abrasion resistance is improved.

### Polymerization Initiator

The polymerization initiator is not particularly limited as long as the polymerization initiator generates active spieces in response to exposure to radiation and starts polymerization of the polymerizable compound described above, and examples thereof include aromatic ketones, acylphosphine oxide compounds, aromatic onium salt compounds, organic peroxides, thio compounds (thioxanthone compounds, thiophenyl group-containing compounds, and the like), α-aminoalkylphenone compounds, hexaarylbiimidazole compounds, ketoxime ester compounds, borate compounds, azinium compounds, metallocene compounds, active ester compounds, compounds including a carbon-halogen bond, and alkylamine compounds. More specifically, examples thereof include acetophenone, acetophenone benzyl ketal, 1-hydroxycyclohexyl phenyl ketone, 2,2-dimethoxy-2-phenylacetophenone, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, Michler's ketone, benzoin propyl ether, benzoin ethyl ether, benzyl dimethyl ketal, 1-(4-isopropylphenyl)-2-hydroxy-2-methylpropane-1-on, 2-hydroxy-2-methyl-1-phenylpropane-1-on, thioxanthone, diethylthioxanthone, 2-isopropylthioxanthone, 2-chlorothioxanthone, 2-methyl-1-[4-(methylthio)phenyl]-2-morpholino-propane-1-on, bis(2,4,6-trimethylbenzoyl)-phenylphosphine oxide, 2,4,6-trimethylbenzoyl-diphenyl-phosphine oxide, 2,4-diethylthioxanthone, and bis-(2,6-dimethoxybenzoyl)-2,4,4-trimethylpentylphosphine oxide.

Examples of commercially available products of such polymerization initiators include IRGACURE 651 (2,2-dimethoxy-1,2-diphenylethane-1-on), IRGACURE 184 (1-hydroxy-cyclohexyl-phenyl-ketone), DAROCUR 1173 (2-hydroxy-2-methyl-1-phenyl-propane-1-on), IRGACURE 2959 (1-[4-(2-hydroxyethoxy)-phenyl]-2-hydroxy-2-methyl-1-propane-1-on), IRGACURE 127 (2-hydroxy-1-{4-[4-(2-hydroxy-2-methyl-propionyl)-benzyl]phenyl]-2-methyl-propane-1-on}, IRGACURE 907 (2-methyl-1-(4-methylthiophenyl)-2-morpholinopropane-1-on), IRGACURE 369 (2-benzyl-2-dimethylamino-1-(4-morpholinophenyl)-butanone-1), IRGACURE 379 (2-(dimethylamino)-2-[(4-methylphenyl)methyl]-1-[4-(4-morpholinyl)phenyl]-1-butanone), DAROCUR TPO (2,4,6-trimethylbenzoyl-diphenyl-phosphine oxide), IRGACURE 819 (bis(2,4,6-trimethylbenzoyl)-phenylphosphine oxide), IRGACURE 784 (bis(η5-2,4-cyclopentadiene-1-yl)-bis(2,6-difluoro-3-(1H-pyrrole-1-yl)-phenyl) titanium), IRGACURE OXE 01 (1.2-octanedion,1-[4-(phenylthio)-,2-(O-benzoyloxime)]), IRGACURE OXE 02 (ethanone,1-[9-ethyl-6-(2-methylbenzoyl)-9H-carbazole-3-yl]-,1-(O-acetyloxime)), and IRGACURE 754 (mixture of 2-[2-oxo-2-phenylacetoxyethoxy]ethyl oxyphenylacetate and 2-(2-hydroxyethoxy)ethyl oxyphenylacetate) (manufactured by BASF), Speedcure TPO, Speedcure DETX (2,4-diethylthioxanthone), and Speedcure ITX (2-isopropylthioxanthone) (manufactured by Lambson), KAYACURE DETX-S (2,4-diethylthioxanthone) (manufactured by Nippon Kayaku Co., Ltd.), Lucirin TPO, LR8893, and LR8970 (manufactured by BASF), and EBECRYL P36 (manufactured by UCB).

Among these, DAROCUR TPO (2,4,6-trimethylbenzoyl-diphenyl-phosphine oxide), and IRGACURE 819 (bis(2,4,6-trimethylbenzoyl)-phenylphosphine oxide) may be selected, and these may be used in combination. When such polymerization initiators are used, there is a tendency that the curability is improved, the bleed of the obtained recorded product is suppressed, and the abrasion resistance is improved.

The content of the polymerization initiator may be 2.5 to 15% by mass, 5 to 12.5% by mass, or 7.5 to 10% by mass with respect to the total amount of the composition. When the content of the polymerization initiator is within the range described above, there is a tendency that the curability is improved, the bleed of the obtained recorded product is suppressed, and the abrasion resistance is improved.

### Dispersing Agent

The dispersing agent is not particularly limited, and examples thereof include dispersing agents conventionally used for preparing a pigment dispersion such as polymer dispersing agents. Specific examples thereof include dispersing agents containing, as a main component, at least one selected from polyoxyalkylene polyalkylene polyamine, vinyl polymer and vinyl copolymer, acrylic polymer and acrylic copolymer, polyester, polyamide, polyimide, polyurethane, amino-based polymer, silicon-containing polymer, sulfur-containing polymer, fluorine-containing polymer, and epoxy resin. Examples of commercially available products of the polymer dispersing agents include AJISPER series manufactured by Ajinomoto Fine-Techno Co., Inc., Solsperse series (such as Solsperse 36000) available from Avecia and Noveon, DISPERBYK series manufactured by BYK Chemie, and DISPARLON series manufactured by Kusumoto Chemicals, Ltd.

The content of the dispersing agent may be 0.1 to 1.5% by mass, 0.25 to 1% by mass, or 0.3 to 0.75% by mass with respect to the total amount of the composition. When the content of the pigment is within the range described above, the dispersion stability of the composition tends to be improved.

### Surfactant

The surfactant is not particularly limited, and for example, as a silicone-based surfactant, polyester-modified silicone or polyether-modified silicone can be used, and particularly polyether-modified polydimethylsiloxane or polyester-modified polydimethylsiloxane may be used. Specific examples thereof include BYK-347, BYK-348, and BYK-UV3500, 3510, 3530, and 3570 (manufactured by BYK).

The content of the surfactant may be 0.1 to 1.5% by mass, 0.25 to 1% by mass, or 0.3 to 0.75% by mass with respect to the total amount of the composition. When the content of the surfactant is within the range described above, there is a tendency that the bleed of the obtained recorded product is suppressed, and the color reproduction range is improved.

### Second Composition Ejection Step

This step is a step of ejecting a second composition which is a radiation-curable composition having a hue angle of 5° to 50° toward a recording medium from an ink jet head. The second composition used in this step is a composition corresponding to a red ink, and a color reproduction range around a region near a hue angle of 0° can be widened by the combination with the first composition.

### Second Composition

The hue angle of the second composition is 5° to 50°, and may be 10° to 40°, 13° to 25°, or 15° to 20°. When the hue angle of the second composition is in the range described above, the color reproduction range tends to be improved.

The composition of the second composition is not particularly limited as long as the first composition is a radiation-curable composition having a hue angle of 5° to 50°, and for example, the first composition contains a pigment, a polymerizable compound, a polymerization initiator, a dispersing agent, and if necessary, a polymerization inhibitor, a surfactant, and other additives. Since the composition of the second composition may be configured as a composition similar to but independent from the first composition except for the kind of the pigment, the pigment will be described below.

The difference in hue angle between the first composition and the second composition may be 10° to 45°, 10° to 40°, or 10° to 35°. When the difference in hue angle between the first composition and the second composition is in the range described above, the color reproduction range tends to be improved.

### Pigment

The hue angle of the second composition is determined by the pigment. The pigment contained in the second composition may be one or more selected from the group consisting of P.R. 166, 168, 149, 177, 179, 254, 255, 264, 242, and 224, and may be P.R. 254 among these. By using such pigment, the color reproduction range can be improved more, and thus a composition having a desired hue angle can be easily prepared. Further, the cured product of the second composition forms a coating film so as to coat the pigment, and therefore there is a tendency that the light resistance of the pigment is improved as compared with the light resistance the pigment originally has. In addition, a combination of two or more kinds of pigments that make the hue angle of the second composition 5° to 50° may be selected. In this view, the hue angle of each individual pigment is not limited to 5° to 50°.

The content of the pigment may be 7.5% by mass or less, 5% by mass or less, 3% by mass or less, or 2% by mass or less with respect to the total amount of the second composition. In addition, the content of the pigment may be 0.1% by mass or more, 0.5% by mass or more, or 1% by mass or more with respect to the total amount of the second composition. When the content of the pigment is within the range described above, the optical density of the obtained recorded product and the dispersion stability of the composition tend to be improved. Particularly, since the cured product of the second composition forms a coating film that coats the pigment and the pigment becomes less likely to sediment at the bottom of the coating film, high color developability can be achieved with a relatively small amount of pigment.

### Exposure Step

This step is a step of exposing each composition to radiation before the elapse of 1 second after landing of each ejected composition to cure the ejected composition. This step will be also referred to as a step of exposing each composition to radiation within 1 second after landing of each ejected composition. The exposure to radiation may be performed within 1 second after landing. To be noted, “exposing each composition to radiation within 1 second after landing” refers to starting the exposure to radiation within 1 second after landing, and this corresponds to the first exposure after landing of the ink. To be noted, the exposure may be finished within 1 second after landing of the composition. In addition, the time of continuation of the exposure to radiation may be 0.5 second or less. The exposure to radiation is performed within 1 second after landing, which may be within 0.5 second, 0.3 second, or 0.2 second. In this case, the image quality is better. In contrast, the exposure may be started after 0.1 second or later, 0.2 second or later, 0.3 second or later, or 0.5 second or later after the landing. In this case, the color reproduction range is better.

The specific method for the exposure is not particularly limited, and in the case of a serial system, the exposure to radiation may be performed in main scanning in which ink is ejected, by using a light source near the ink jet head. In addition, in the case of a line system, the exposure to radiation may be performed by using a light source positioned downstream of the ink jet head in the transport direction. The exposure may be exposure for finishing curing or exposure for preliminary curing. To be noted, in the case where this exposure is for preliminary curing, the exposure may be performed for the second time and more.

The preliminary curing is performed for curing only a part of the composition, and in this case, the composition is supposed to be subjected to finishing curing by, for example, being further exposed to radiation after the preliminary curing. The finishing curing is performed for sufficiently curing the obtained product to such a degree that the product can be used as a recorded product, a modeled product, or the like.

At this time, an LED may be used as a radiation source. An LED is small and does not generate much heat, and is thus easy to dispose relatively near the ink jet head. Therefore, an LED is suitable for the exposure step of exposing each composition to radiation within 1 second after landing. In addition, in the case of using an LED, there is a tendency that the color reproduction range becomes narrower, and therefore the present disclosure is particularly beneficial. The irradiation peak wavelength of the LED may be 350 nm to 420 nm.

The exposure step for the first composition and the exposure step for the second composition may be collectively performed as one exposure step. In this case, the first composition is exposed to radiation within 1 second after landing of the first composition, and, simultaneously, the second composition is also exposed to radiation within 1 second after landing of the second composition in the same exposure.

Alternatively, the exposure step for the first composition and the exposure step for the second composition may be performed separately. In this case, the first composition is exposed to radiation within 1 second after landing of the first composition, and the second composition is separately exposed to radiation within 1 second after landing of the second composition.

According to the former, the exposure can be performed in one exposure step, and according to the latter, the start time for exposure can be easily adjusted in accordance with the time of landing of the composition.

The landing of the composition may be landing on the recording medium or landing on the composition that has already landed.

The irradiation energy of the radiation may be 5 to 2000 mJ/cm². In the case where this exposure step corresponds to preliminary curing, the irradiation energy may be 2 to 100 mJ/cm², 5 to 50 mJ/cm², or 10 to 30 mJ/cm².

In the case where the exposure step corresponds to finishing curing, the irradiation energy may be 50 to 2000 mJ/cm², 150 to 800 mJ/cm², or 200 to 400 mJ/cm².

When the irradiation energy of the radiation is within the range described above, the bleed of the obtained recorded product tends to be suppressed.

The irradiation peak intensity of the radiation may be 100 mW/cm² or more, 150 to 20000 mW/cm², or 200 to 10000 mW/cm². In addition, in the case where the exposure step corresponds to preliminary curing, the irradiation peak intensity may be 200 to 1000 mW/cm² or 250 to 500 mW/cm². Further, in the case where the exposure step corresponds to preliminary curing, the irradiation peak intensity may be 1000 to 7000 mW/cm², 1500 to 5000 mW/cm², or 2000 to 4000 mW/cm². When the irradiation energy of the radiation is within the range described above, the bleed of the obtained recorded product tends to be suppressed.

### Other Ejection Steps

The recording method of the present embodiment may further include a step of ejecting a radiation-curable cyan composition from the ink jet head and a step of ejecting a radiation-curable yellow composition from the ink jet head, in addition to the ejection steps described above. As a result of this, colors of all the hue angles can be reproduced in a good balance by combining the cyan, magenta, and yellow compositions. To be noted, as an exposure step, the compositions may be exposed to radiation within 1 second after landing of the first composition or the second composition. Alternatively, an exposure step for curing the cyan composition or the yellow composition may be additionally provided. In addition, the first composition, the second composition, the cyan composition, and the yellow composition may be collectively exposed to radiation.

The cyan composition may be exposed to radiation within 1 second after landing thereof, and the yellow composition may be exposed to radiation within 1 second after landing thereof. The conditions such as the irradiation energy and the irradiation peak intensity of the exposure step may be independently set in ranges similar to those of the exposure step described above.

The hue angle of the cyan composition may be 210° to 260°. The hue angle of the cyan composition may be positioned downstream of the first composition in a clockwise direction in the a*b* plane. In addition, the pigment used for the cyan composition is not particularly limited, and examples thereof include P.B. 15 series (for example, 15:3), 16, and 17.

The hue angle of the yellow composition may be 80° to 110°. The hue angle of the yellow composition may be larger than that of the second composition. In addition, the pigment used for the yellow composition is not particularly limited, and examples thereof include P.Y. 155, 150, 74, and 180.

In addition, the recording method of the present embodiment may further include a step of ejecting a radiation-curable third composition having a hue angle larger than that of the second composition and smaller than that of the yellow composition from the ink jet head in addition to the ejection steps described above. As a result of this, the color reproduction range tends to be improved. To be noted, as an exposure step, the third composition may be also exposed to radiation to cure in the step of exposing the compositions to radiation within 1 second after landing of the first composition or the second composition. Alternatively, an exposure step for curing the third composition may be additionally provided. Alternatively, the first composition, the second composition, and the third composition may be collectively exposed to radiation. In the exposure step of exposing the third composition to cure, the third composition may be exposed to radiation within 1 second after landing thereof. The conditions such as the irradiation energy and the irradiation peak intensity of the exposure step may be independently set in ranges similar to those of the exposure step described above.

To be noted, the third composition can have a composition similar to that exemplified for the first composition except that the pigment is selected such that the hue angle thereof is larger than that of the second composition and smaller than that of the yellow composition. The hue angle of the third composition may be 55° to 80°. In addition, the pigment used for the third composition is not particularly limited, and examples thereof include P.O. 43. When such a third composition is used, the color reproduction range from red to yellow tends to be improved. The third composition may be, for example, an orange composition.

Further, the recording method of the present embodiment may further include a step of ejecting a radiation-curable clear composition from the ink jet head in addition to the ejection steps described above. As a result of this, there is a tendency that the glossy feel of the obtained recorded product is improved and the light resistance of the recorded product is also improved. To be noted, as an exposure step, an exposure step for curing the clear composition may be additionally provided, or the first composition, the second composition, and the clear composition may be collectively exposed to radiation after landing of all of these, as long as the compositions are exposed to radiation within 1 second after landing of the first composition and the second composition.

To be noted, the clear composition is not an ink used for coloring the recording medium but an ink used for other purposes. Examples of the other purposes include adjustment of glossiness of the recording medium, improvement of properties of the recorded product such as abrasion resistance, and improvement of fixability and color developability of the color inks. For the components of the clear composition other than pigment, the polymerizable compound, the polymerization initiator, the surfactant, and so forth exemplified for the first composition can be used. The content of colorant in the clear composition may be 0.1% by mass or less or 0.05% by mass or less.

### Other Exposure Steps

In the recording method of the present embodiment, exposure to radiation may be performed only in the exposure step described above. In the case of sufficiently curing the compositions to the state of finishing curing by one exposure of the exposure step, irradiation of a relatively large irradiation energy is required, and the color reproduction range of the recorded product obtained thereby tends to be narrow. Therefore, the present disclosure is particularly beneficial. Alternatively, in the recording method of the present exemplary embodiment, a step of further exposing each composition to radiation after the exposure step described above and after the elapse of 1 second after landing of each composition may be further provided. As a result of this, the curing becomes more reliable, the color reproduction range is improved, and the abrasion resistance of the obtained recorded product tends to be improved. In addition, by performing the exposure step multiple times as described above, an earlier exposure step may be regarded as preliminary curing and a later exposure step may be regarded as finishing curing. In this case, the bleed can be suppressed by the preliminary curing, and further sufficient curing can be performed by the finishing curing.

In the case of performing the step of finishing curing as the step of further performing exposure, the irradiation energy and the irradiation peak intensity therefor can be set in the range used for the step of performing exposure for the finishing curing described above. The step of further performing exposure can be performed by using the LED described above.

### Ink Jet Apparatus

An ink jet apparatus of the present embodiment includes the ink jet head that performs the ink jet recording method described above, and a radiation source. According to the difference in the type of the ink jet head to be used, the ink jet apparatus is referred to as a line printer or a serial printer. Apparatuses of the two types will be described below.

### Line Printer

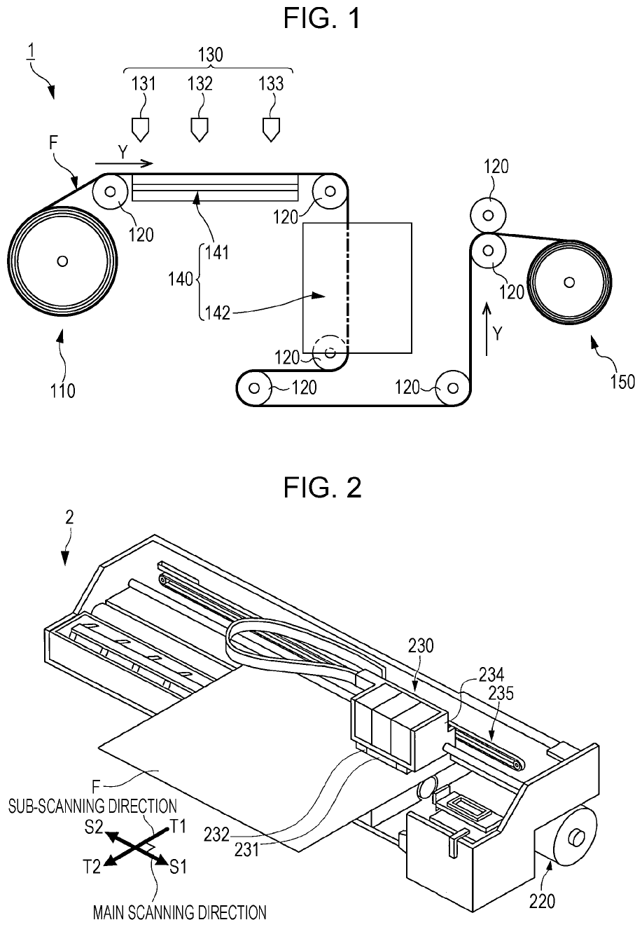

FIG. 1 is a schematic side view of a line printer. As illustrated in FIG. 1, a line printer 1 includes a feeding unit 110 for a recording medium, transport units 120, a recording unit 130, a drying unit 140, and a discharge unit 150.

Here, the feeding unit 110 feeds a recording medium F to the transport units 120, and the transport units 120 transport the recording medium F fed from the feeding unit 110 to the recording unit 130, the drying unit 140, and the discharge unit 150. Specifically, the transport units 120 each include a delivering roller, and transport the delivered recording medium F in a delivering direction Y.

In addition, the recording unit 130 includes an ink jet head 131 that ejects radiation-curable compositions onto the recording medium F transported by the transport units 120, and light sources 132 and 133 that emit radiation toward attached compositions. In the case of a line printer, a line head having a length equal to or longer than a length corresponding to the width of the recording medium is provided as the ink jet head 131, the head is fixed to be (approximately) immobile, and the recording is performed by single pass. The pass will be also referred to as scan.

In the present embodiment, the transport speed of the recording medium and the distance between the ink jet head 131 and the light source 132 are adjusted to make the recording method described above possible. To be noted, although only one ink jet head is illustrated in FIG. 1, the configuration is not limited to this, and a plurality of ink jet heads may be provided in correspondence with kinds of compositions.

The drying unit 140 is used for driving the compositions attached to the recording medium as necessary, and includes a drying portion 141 (platen heater) provided to oppose the recording unit 130, and a drying portion 142 provided downstream of the recording unit 130. Further, the discharge unit 150 is provided to discharge a recorded product to the outside of the line printer 1. The drying unit 140 does not have to be provided in the case where there is no need for drying.

### Serial Printer

FIG. 2 is a perspective view of a serial printer. As illustrated in FIG. 2, a serial printer 2 includes a transport unit 220 and a recording unit 230. The transport unit 220 transports the recording medium F fed to the serial printer to the recording unit 230, and discharges the recording medium to the outside of the serial printer after recording. Specifically, the transport unit 220 includes a delivering roller, and transports the delivered recording medium F in a sub-scanning direction Tl.

In addition, the recording unit 230 includes an ink jet head 231 that ejects radiation-curable compositions onto the recording medium F transported from the transport unit 220, light sources 232 that emits radiation toward the attached compositions, a carriage 234 on which these are mounted, and a carriage moving mechanism 235 that moves the carriage 234 in main scanning directions S1 and S2 of the recording medium F. In the case of a serial printer, a head having a length smaller than the width of the recording medium is provided as the ink jet head 131, the head moves, and recording is performed by multi-pass. In the serial printer, the head 231 and the light sources 232 are mounted on the carriage 234 that moves in a predetermined direction, and compositions are ejected onto the recording medium by the head moving in accordance with the movement of the carriage. As a result of this, recording is performed by 2 or more passes (multi-pass). The pass will be also referred to as main scanning. Sub-scanning of transporting the recording medium is performed between passes. That is, the main scanning and the sub-scanning are alternately performed. In the case of performing the exposure step on landed inks in the main scanning in which inks are ejected and landed, exposure to radiation can be easily performed within 1 second after landing.

In addition, in the case of exposing the landed inks to radiation after the main scanning in which inks are ejected and landed, exposure to radiation can be easily performed after the elapse of 1 second after landing. Therefore, this may be performed as the step of additional exposure. In this case, for example, the landed inks may be exposed to radiation in subsequent main scanning after the main scanning in which the inks are ejected and landed.

To be noted, in the case where the distance of one pass of sub-scanning with respect to the length of an ink jet head nozzle row in the sub-scanning direction is, for example, one eighth, ink is attached to the same position of the recording medium by 8 passes. This case will be referred to as 8-pass. In the case where the number of passes is large, by attaching ink to the same position of the recording medium by multiple passes, the attachment amount of ink attached by one pass can be reduced, and thus deterioration of image quality caused by contact of ink dots can be suppressed.

In the present embodiment, the transport speed of the recording medium, the movement speed of the carriage, and the distance between the ink jet head 231 and the light sources 232 are adjusted to make the recording method described above possible. To be noted, although FIG. 2 illustrates an embodiment in which a light source is mounted on a carriage, the configuration is not limited to this, and a light source not mounted on a carriage may be provided.

### Examples

The present disclosure will be described in more detail with reference to Examples and Comparative Examples. The present disclosure should not be limited in any way by the following examples.

### Ingredients of Ink Composition

Main ingredients for the ink compositions used for Examples and Comparative Examples that will be described later are as follows.

### Polymerizable Compound

PEA (phenoxyethyl acrylate, manufactured by Osaka Organic Chemical Industry LTD.)
VEER (2-(2-vinyloxyethoxy)ethyl acrylate, manufactured by Nippon Shokubai Co., Ltd.)
DPGDA (dipropylene glycol diacrylate, manufactured by Sartomer) Polymerization Initiator
819 (IRGACURE 819, manufactured by BASF)
TPO (DAROCURE TPO, manufactured by BASF) Surfactant
UV3500 (BYK-UV3500, manufactured by BYK) Polymerization Inhibitor
Methyhydroquinone (hereinafter referred to as “MEHQ”) Dispersing Agent
Solsperse 36000 (manufactured by Lubrizol)

### Preparation of Pigment Dispersions

Pigment mixtures were prepared by mixing pigments and dispersing agents shown in the table below in mass ratios shown in the table. Monomer mixture liquids were prepared by mixing main monomers (PEA or PEA and VEEA) in mass ratios show in the table below, and pigment dispersions were prepared by mixing and stirring the pigment mixtures with the monomer mixture liquids by a bead mill.

### Preparation of Compositions

The pigment dispersion obtained as described above were mixed with remaining monomers and other ingredients in ratios shown in the table below and stirred sufficiently, and thus respective compositions were obtained. To be noted, the unit of values shown in Table 1 is % by mass, and the sum thereof is 100.0% by mass.

TABLE 1

| | Bk | C | Y | Or | CL | M1 | M2 | M3 | M4 | M5 | M6 | M7 |
|---|---|---|---|---|---|---|---|---|---|---|---|---|
| PEA | 34.8 | 34.2 | 34.8 | 34.8 | 37.3 | 34.8 | 34.8 | 34.8 | 34.8 | 34.8 | 34.8 | 32.8 |
| VEEA | 20 | 20 | 20 | 20 | 20 | 20 | 20 | 20 | 20 | 20 | 20 | 20 |
| DPGDA | 34 | 34 | 34 | 34 | 34 | 34 | 34 | 34 | 34 | 34 | 34 | 34 |
| 819 | 4 | 4 | 4 | 4 | 4 | 4 | 4 | 4 | 4 | 4 | 4 | 4 |
| TPO | 4 | 4 | 4 | 4 | 4 | 4 | 4 | 4 | 4 | 4 | 4 | 4 |
| BYK-UV3500 | 0.5 | 0.5 | 0.5 | 0.5 | 0.5 | 0.5 | 0.5 | 0.5 | 0.5 | 0.5 | 0.5 | 0.5 |
| MEHQ | 0.2 | 0.2 | 0.2 | 0.2 | 0.2 | 0.2 | 0.2 | 0.2 | 0.2 | 0.2 | 0.2 | 0.2 |
| Carbon Black | 2 | | | | | | | | | | | |
| Pigment Blue15:3 | | 2.5 | | | | | | | | | | |
| Pigment Yellow155 | | | 2 | | | | | | | | | |
| Pigment Orange 43 | | | | 2 | | | | | | | | |
| Pigment Red 122 | | | | | | 2 | | | | | 1 | 4 |
| Pigment Red 185 | | | | | | | 2 | | | | | |
| Pigment Violet 32 | | | | | | | | 2 | | | | |
| Pigment Red 202 | | | | | | | | | 2 | | | |
| Pigment Red 209 | | | | | | | | | | 2 | | |
| Pigment Red 254 | | | | | | | | | | | | |
| Pigment Red 177 | | | | | | | | | | | 1 | |
| Pigment Red 179 | | | | | | | | | | | | |
| Pigment Red 224 | | | | | | | | | | | | |
| Pigment Red 168 | | | | | | | | | | | | |
| Pigment Red 242 | | | | | | | | | | | | |
| Pigment Red 149 | | | | | | | | | | | | |
| Dispersing Agent | 0.5 | 0.6 | 0.5 | 0.5 | | 0.5 | 0.5 | 0.5 | 0.5 | 0.5 | 0.5 | 0.5 |
| Sum | 100 | 100 | 100 | 100 | 100 | 100 | 100 | 100 | 100 | 100 | 100 | 100 |
| Hue Angle (°) | — | 225 | 94 | 56 | — | −18 | −7 | −25 | −22 | −27 | 0 | −18 |
| | M8 | M9 | R1 | R2 | R3 | R4 | R5 | R6 | R7 | R8 | R9 | R10 |
| PEA | 39.8 | 44.8 | 34.8 | 34.8 | 34.8 | 34.8 | 34.8 | 34.8 | 34.8 | 32.8 | 42.8 | 42.8 |
| VEEA | 10 | | 20 | 20 | 20 | 20 | 20 | 20 | 20 | 20 | 5 | 5 |
| DPGDA | 39 | 44 | 34 | 34 | 34 | 34 | 34 | 34 | 34 | 34 | 41 | 41 |
| 819 | 4 | 4 | 4 | 4 | 4 | 4 | 4 | 4 | 4 | 4 | 4 | 4 |
| TPO | 4 | 4 | 4 | 4 | 4 | 4 | 4 | 4 | 4 | 4 | 4 | 4 |
| BYK-UV3500 | 0.5 | 0.5 | 0.5 | 0.5 | 0.5 | 0.5 | 0.5 | 0.5 | 0.5 | 0.5 | 0.5 | 0.5 |
| MEHQ | 0.2 | 0.2 | 0.2 | 0.2 | 0.2 | 0.2 | 0.2 | 0.2 | 0.2 | 0.2 | 0.2 | 0.2 |
| Carbon Black | | | | | | | | | | | | |
| Pigment Blue15:3 | | | | | | | | | | | | |
| Pigment Yellow155 | | | | | | | | | | | | |
| Pigment Orange 43 | | | | | | | | | | | | |
| Pigment Red 122 | | | | | | | | | | | | |
| Pigment Red 185 | 2 | 2 | | | | | | | | | | |
| Pigment Violet 32 | | | | | | | | | | | | |
| Pigment Red 202 | | | | | | | | | | | | |
| Pigment Red 209 | | | | | | | | | | | | |
| Pigment Red 254 | | | 2 | | | | | | | 4 | 2 | 2 |
| Pigment Red 177 | | | | 2 | | | | | | | | |
| Pigment Red 179 | | | | | 2 | | | | | | | |
| Pigment Red 224 | | | | | | 2 | | | | | | |
| Pigment Red 168 | | | | | | | 2 | | | | | |
| Pigment Red 242 | | | | | | | | 2 | | | | |
| Pigment Red 149 | | | | | | | | | 2 | | | |
| Dispersing Agent | 0.5 | 0.5 | 0.5 | 0.5 | 0.5 | 0.5 | 0.5 | 0.5 | 0.5 | 0.5 | 0.5 | 0.5 |
| Sum | 100 | 100 | 100 | 100 | 100 | 100 | 100 | 100 | 100 | 100 | 100 | 100 |
| Hue Angle (°) | −18 | −18 | 18 | 10 | 30 | 39 | 42 | 43 | 36 | 18 | 18 | 18 |

### Measurement Method for Hue Angle

The hue angle is a hue angle in the case where a* is 60. The compositions obtained in the manner described above were injected into an ink jet recording apparatus (product name “SC-S30650”, manufactured by Seiko Epson Corporation), and attached to a recording medium (white vinyl chloride medium 5829R manufactured by Mactac). Then, a color measurement pattern was generated by curing the compositions by radiating ultraviolet light having an irradiation energy of 500 mJ/cm² and a peak intensity of 1000 mW/cm² thereto from an LED having a peak wavelength of 395 nm as a light source. To be noted, the color measurement pattern generated at this time included a plurality of patterns having different attachment amount of the compositions by an increment of 0.1 mg/inch². To be noted, the peak intensity is measured at a distance equivalent to the distance between the light source and the surface of the recording medium by using an ultraviolet light intensity meter UM-10 and a light receiving unit UM-400 (both manufactured by Konica Minolta Sensing).

Color measurement of the color measurement pattern was performed in conditions of a light source of D50, a field angle of 2°, a white standard of absolute white, and no light source filter by using a spectrometer (Spectrolino SPM 50 manufactured by GretagMacbeth) conforming to CIELAB. In the color measurement pattern, a region where a* of color measurement value was 60 or more and the amount of attachment of the composition was the smallest was specified, and the hue angle of that region was measured. To be noted, the hue angles of other compositions than the first composition and the second composition were hue angles obtained at the same attachment amount as the attachment amount of the first composition at which the hue angle of the first composition was calculated.

### Ink Set

The compositions prepared as described above were combined as follows to make composition sets.

TABLE 2

| Set Name | S1 | S2 | S3 | S4 | S5 | S6 | S7 | S8 | S9 | S10 | S11 | S12 | S13 |
|---|---|---|---|---|---|---|---|---|---|---|---|---|---|
| First | M1 | M2 | M3 | M4 | M5 | M7 | M8 | M9 | M1 | M1 | M1 | M1 | M1 |
| Composition | | | | | | | | | | | | | |
| Second | R1 | R1 | R1 | R1 | R1 | R8 | R9 | R10 | R2 | R3 | R4 | R5 | R6 |
| Composition | | | | | | | | | | | | | |
| Other | Bk | Bk | Bk | Bk | Bk | Bk | Bk | Bk | Bk | Bk | Bk | Bk | Bk |
| Compositions | C | C | C | C | C | C | C | C | C | C | C | C | C |
| | Y | Y | Y | Y | Y | Y | Y | Y | Y | Y | Y | Y | Y |

| Set Name | S14 | S15 | S16 | S17 | S18 | S19 | S20 | S21 | S22 | S23 | S24 | S25 | S26 |
|---|---|---|---|---|---|---|---|---|---|---|---|---|---|
| First | M1 | M2 | M3 | M4 | M4 | M1 | M2 | M3 | M6 | — | — | — | M1 |
| Composition | | | | | | | | | | | | | |
| Second | R7 | R3 | R2 | R1 | R1 | — | — | — | — | R1 | R2 | R7 | — |
| Composition | | | | | | | | | | | | | |
| Other | Bk | Bk | Bk | Bk | Bk | Bk | Bk | Bk | Bk | Bk | Bk | Bk | Bk |
| Compositions | C | C | C | C | C | C | C | C | C | C | C | C | C |
| | Y | Y | Y | Y | Y | Y | Y | Y | Y | Y | Y | Y | Y |
| | | | | Or | CL | | | | | | | | Or |

### System 1

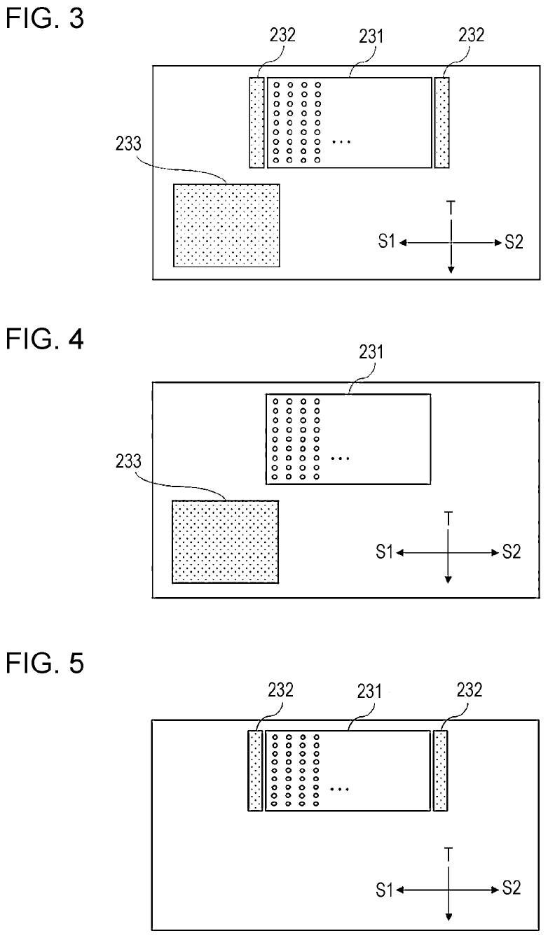

A modified apparatus of an ink jet recording apparatus (product name “SC-S30650”, manufactured by Seiko Epson Corporation) in which an ink jet head on a carriage and light sources (LED having a peak wavelength of 395 nm) were arranged as illustrated in FIG. 3 was prepared as a serial printer. Then, each 6 nozzle rows arranged in the main scanning direction of the ink jet head was filled with a corresponding ink. Inks were ejected from respective nozzles to be attached to the recording medium in the main scanning in which the carriage was moved, and the attached inks were exposed to radiation from the light sources 232 and 233. To be noted, the inks attached to the recording medium were immediately exposed to radiation from the light sources 232 adjacent to the ink jet head in the main scanning. Then, the inks were subjected to exposure for the second time by the light source 233 provided at a position away from the ink jet head in the main scanning after the main scanning in which the exposure for the first time was performed. The movement speed (main scanning speed) of the ink jet head was adjusted such that the exposure by the light sources 232 was performed for each ink within 1 second after landing of the ink. The transport speed and the inter-pass stopping time were adjusted such that the exposure by the light source 233 was performed for each ink within 1 second after the elapse of 1 second after landing of the ink. To be noted, the difference in the time from landing of the ink to the start of exposure derived from the positional relationship of the 6 nozzle rows in the main scanning direction was very small, and the longest time from landing of the ink to the start of exposure of the nozzle row is shown as the time in the table.

The nozzle density of each nozzle row of the ink jet head was set to 360 dpi. In addition, the recording resolution of a recorded pattern was set such that the maximum density of pixels was 1440×1440 dpi for each ink, a plurality of dots (droplets) were placed in each pixel or in a plurality of pixels in a dispersed manner, and the dots were arranged as uniformly as possible in the recorded pattern for each ink. The recording described above was performed by 8-pass printing.

### System 2

Recording was performed in the same manner as System 1 except that a modified apparatus of an ink jet recording apparatus (product name “SC-S30650”, manufactured by Seiko Epson Corporation) in which an ink jet head and a light source were arranged as illustrated in FIG. 4 was used. To be noted, in System 2, the exposure for the first time was performed by the light source 233 provided in a position away from the ink jet head in main scanning after main scanning in which ink was ejected and landed, and therefore a certain time was required between attachment of ink to exposure to radiation.

### System 3

Recording was performed in the same manner as System 1 except that a modified apparatus of an ink jet recording apparatus (product name “SC-S30650”, manufactured by Seiko Epson Corporation) in which an ink jet head and light sources were arranged as illustrated in FIG. 5 was used. To be noted, System 3 was the same as System 1 except that exposure to radiation was not performed by the light source 233 provided at a position away from the ink jet head.

### System 4

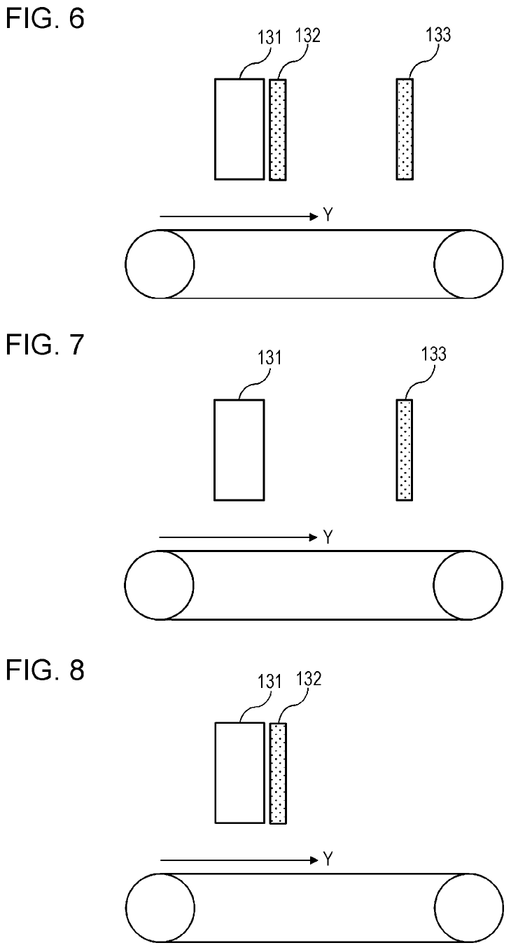

A modified apparatus of an ink jet recording apparatus (product name “L-4533”, manufactured by Seiko Epson Corporation) in which an ink jet head and light sources (LED having a peak wavelength of 395 nm) were arranged as illustrated in FIG. 6 was prepared as a line printer. An ink jet head 131 included six nozzle rows arranged in the scanning direction (transport direction). Each nozzle row was filled with a corresponding ink. Inks were ejected from respective nozzle rows to be attached to the recording medium, and the attached inks were exposed to radiation from a light source 132. To be noted, the inks attached to the recording medium were immediately exposed to radiation from the light source 132 provided near the ink jet head, and were exposed to radiation for the second time from a light source 133 provided at a position away from the ink jet head. The transport speed of the recording medium was adjusted such that each ink was exposed to radiation from the light source 132 within 1 second after landing of the ink, and the light source 133 was provided at a position away from the ink jet head on the downstream side in the transport direction such that each ink was exposed to radiation from the light source 133 after the elapse of 1 second after landing of each ink. To be noted, the difference in the time from landing of the ink to the start of exposure derived from the positional relationship of the 6 nozzle rows in the scanning direction (transport direction) was very small, and the longest time from landing of the ink to the start of exposure of the nozzle row is shown as the time in the table.

The nozzle density of each nozzle row of the ink jet head was set to 360 dpi. In addition, the recording resolution of the recorded pattern was set to 360 dpi in the width direction of the line head and 1440 dpi in the sheet feeding direction such that a plurality of dots (droplets) were placed in each pixel or in a plurality of pixels in a dispersed manner, and the dots were arranged as uniformly as possible in the recorded pattern for each ink. The recording described above was performed by 1-pass printing.

### System 5

Recording was performed in the same manner as System 4 except that a modified apparatus of an ink jet recording apparatus (product name “L-4533”, manufactured by Seiko Epson Corporation) in which an ink jet head and a light source were arranged as illustrated in FIG. 7 was used. To be noted, in System 5, the exposure for the first time was performed by the light source 133 provided in a position away from the ink jet head, and therefore a certain time was required between attachment of ink to exposure to radiation.

### System 6

Recording was performed in the same manner as System 4 except that a modified apparatus of an ink jet recording apparatus (product name “L-4533”, manufactured by Seiko Epson Corporation) in which an ink jet head and a light source were arranged as illustrated in FIG. 8 was used. To be noted, System 6 was the same as System 4 except that exposure to radiation was not performed by the light source 133 provided at a position away from the ink jet head.

In addition, in Systems 1 and 4 described above, the exposure for finishing curing was performed by the light source on the downstream side after the elapse of 1 second after landing with a peak wavelength of 2000 mW/cm² and an irradiation energy of 200 mJ/cm². Also in the other systems, the exposure for the second time was performed after the elapse of 1 second after landing such that the total irradiation energy was 200 mJ/cm² or more in examples in which the irradiation energy for the first exposure was lower than 200 mJ/cm².

Further, a reference example test was also carried out. In the reference example, solvent-based ink compositions shown in Table 7 were used. These compositions are not radiation-curable.

### Solvent

Diethylene glycol ethyl methyl ether (manufactured by Nippon Nyukazai Co., Ltd.)
Diethylene glycol diethyl ether (manufactured by Nippon Nyukazai Co., Ltd.)
γ-butyrolactone (manufactured by Mitsubishi Chemical Corporation) Resin
SOLBIN CL (manufactured by Nisshin Chemical Industry Co., Ltd.) Surfactant
BYK-340 (manufactured by BYK)

### Dispersing Agent

Solsperse 24000 (manufactured by Lubrizol)

Pigment mixtures were prepared by mixing pigments and dispersing agents shown in Table 7 in mass ratios shown in the table. Solvent mixture liquids containing solvents in mass ratios shown in the table were prepared, mixed with the pigment mixtures, and stirred by a bead mill, and thus pigment dispersions were prepared. The obtained pigment dispersions were mixed with remaining solvents and other ingredients in ratios shown in the table below and stirred sufficiently, and thus respective compositions were obtained. To be noted, the unit of values shown in Table 7 is % by mass, and the sum thereof is 100.0% by mass.

### Color Reproduction Range

Color measurement of an evaluation pattern was performed in the same color measurement conditions as in the measurement of hue angle.

Patterns of all colors reproducible by the ink set was generated as the evaluation pattern by attaching each ink of the ink set by an arbitrary attachment amount. Printable gamut volume in the L*a*b* space was calculated from all color measurement values, and the color reproduction range was evaluated in accordance with the evaluation criteria below.

A: The gamut volume was 600 thousand or more.
B: The gamut volume was 550 thousand or more and less than 600 thousand.
C: The gamut volume was 500 thousand or more and less than 550 thousand.
D: The gamut volume was less than 500 thousand.

### Evaluation of Image Quality (Bleed)

The evaluation pattern was generated by attaching each ink constituting the ink set was attached by an equal amount such that the total attachment amount was 10 mg/inch² and performing exposure to ultraviolet light in the conditions of the recording test described above.

To be noted, in the case where the ink set included a clear ink, the evaluation pattern was generated by attaching each ink other than the clear ink by an equal amount such that the total attachment amount was 10 mg/inch², performing exposure to ultraviolet light in the conditions of the recording test described above, then attaching the clear ink onto this by an attachment amount of 2 mg/inch², and performing exposure to ultraviolet light again in the same conditions.

Whether occurrence of bleed was recognized in the evaluation pattern obtained as described above was visually observed, and evaluation was made in accordance with the evaluation criteria below. To be noted, the same recording medium as in the measurement of hue angle was used.

### Evaluation Criteria

A: No unevenness in density derived from concentration of dots was observed in the pattern, and no part where ink was concentrated and the color looked darker was observed in the edge of the pattern.
B: No unevenness in density derived from concentration of dots was observed in the pattern, and a small part where ink was concentrated and the color looked darker was observed in the edge of the pattern.
C: Slight unevenness in density derived from concentration of dots was observed in the pattern.
D: Prominent unevenness in density derived from concentration of dots was observed in the pattern.

### Image Quality (Glossiness)

Light from a fluorescent lamp was reflected on the evaluation pattern generated for image quality (bleed) evaluation, thus the difference in the glossy feel between the base of the recording medium and the pattern portion was visually observed, and evaluation was made in accordance with the following evaluation criteria.

A: No difference in the glossy feel was recognized.
B: Slight difference in the glossy feel was recognized.
C: Prominent difference in the glossy feel was recognized.

### Evaluation of Ejection Stability

Recording was continuously performed for 1 hour by using a recording apparatus, and flushing from nozzles was performed every 1 hour. This operation was continued for 10 hours in total, and whether ejection incapability occurred in nozzle rows used for recording using the first ink and the second ink was inspected in the end. Evaluation was made on the basis of the inspection results in accordance with the evaluation criteria below. To be noted, the average of the ratio of unejectable nozzles used for recording using the first ink and the second ink was used as the ratio of unejectable nozzles.

A: 1% or less of all the nozzles were incapable of ejection.
B: 2 to 3% of all the nozzles were incapable of ejection.
C: 4 to 5% of all the nozzles were incapable of ejection.
D: 6% or more of all the nozzles were incapable of ejection.

The evaluation results are shown in the tables below.

TABLE 3

| | Example | | | | | | | | | |
|---|---|---|---|---|---|---|---|---|---|---|
| | 1 | 2 | 3 | 4 | 5 | 6 | 7 | 8 | 9 | 10 |
| Set No. | S1 | S2 | S3 | S4 | S5 | S6 | S7 | S8 | S9 | S10 |
| Recording System | Sys- | Sys- | Sys- | Sys- | Sys- | Sys- | Sys- | Sys- | Sys- | Sys- |
| | tem 3 | tem 3 | tem 3 | tem 3 | tem 3 | tem 3 | tem 3 | tem 3 | tem 3 | tem 3 |
| Time from landing of ink to first | 0.25 | 0.25 | 0.25 | 0.25 | 0.25 | 0.25 | 0.25 | 0.25 | 0.25 | 0.25 |
| exposure to radiation (sec) | | | | | | | | | | |
| Irradiation energy of the | 200 | 200 | 200 | 200 | 200 | 200 | 200 | 200 | 200 | 200 |
| exposure above (mJ/cm²) | | | | | | | | | | |
| Irradiation peak intensity of the | 2000 | 2000 | 2000 | 2000 | 2000 | 2000 | 2000 | 2000 | 2000 | 2000 |
| exposure above (mW/cm²) | | | | | | | | | | |
| Color Reproduction Range | A | C | C | B | C | C | B | A | B | B |
| Image Quality (Bleed) | B | B | B | B | B | C | B | C | B | B |
| Image Quality (Glossiness) | C | C | C | C | C | B | B | B | C | C |
| Ejection Stability (First and | B | B | B | B | B | C | B | A | B | B |
| Second Inks) | | | | | | | | | | |

TABLE 4

| | Example | | | | | | | | | |
|---|---|---|---|---|---|---|---|---|---|---|
| | 11 | 12 | 13 | 14 | 15 | 16 | 17 | 18 | 19 | 20 |
| Set No. | S2 | S12 | S3 | S14 | S15 | S16 | S17 | S18 | S1 | S1 |
| Recording System | Sys- | Sys- | Sys- | Sys- | Sys- | Sys- | Sys- | Sys- | Sys- | Sys- |
| | tem 3 | tem 3 | tem 3 | tem 3 | tem 3 | tem 3 | tem 3 | tem 3 | tem 3 | tem 3 |
| Time from landing of ink to first | 0.25 | 0.25 | 0.25 | 0.25 | 0.25 | 0.25 | 0.25 | 0.25 | 0.1 | 0.5 |
| exposure to radiation (sec) | | | | | | | | | | |
| Irradiation energy of the | 200 | 200 | 200 | 200 | 200 | 200 | 200 | 200 | 200 | 200 |
| exposure above (mJ/cm²) | | | | | | | | | | |
| Irradiation peak intensity of the | 2000 | 2000 | 2000 | 2000 | 2000 | 2000 | 2000 | 2000 | 2000 | 2000 |
| exposure above (mW/cm²) | | | | | | | | | | |
| Color Reproduction Range | C | C | C | C | B | B | A | B | B | A |
| Image Quality (Bleed) | B | B | B | B | B | B | B | B | A | B |
| Image Quality (Glossiness) | C | C | C | C | C | C | C | A | C | C |
| Ejection Stability (First and | B | B | B | B | B | B | B | B | C | B |
| Second Inks) | | | | | | | | | | |

TABLE 5

| | Example | | | | | | | | | | |
|---|---|---|---|---|---|---|---|---|---|---|---|
| | 21 | 22 | 23 | 24 | 25 | 26 | 27 | 28 | 29 | 30 | 31 |
| Set No. | S1 | S1 | S1 | S2 | S2 | S2 | S2 | S2 | S2 | S2 | S2 |
| Recording System | Sys- | Sys- | Sys- | Sys- | Sys- | Sys- | Sys- | Sys- | Sys- | Sys- | Sys- |
| | tem 3 | tem 3 | tem 3 | tem 1 | tem 1 | tem 1 | tem 1 | tem 4 | tem 6 | tem 6 | tem 3 |
| Time from landing of ink to first | 0.8 | 0.25 | 0.25 | 0.25 | 0.15 | 0.15 | 0.15 | 0.15 | 0.25 | 0.25 | 0.25 |
| exposure to radiation (sec) | | | | | | | | | | | |
| Irradiation energy of the | 200 | 400 | 800 | 50 | 10 | 10 | 5 | 10 | 200 | 400 | 200 |
| exposure above (mJ/cm²) | | | | | | | | | | | |
| Irradiation peak intensity of the | 2000 | 4000 | 6000 | 500 | 300 | 150 | 300 | 300 | 2000 | 4000 | 1000 |
| exposure above (mW/cm²) | | | | | | | | | | | |
| Color Reproduction Range | A | B | C | B | A | A | A | A | B | C | B |
| Image Quality (Bleed) | C | A | A | B | B | C | C | B | B | A | C |
| Image Quality (Glossiness) | B | C | C | B | B | A | A | B | B | C | B |
| Ejection Stability (First and | A | C | C | A | B | A | A | B | B | C | A |
| Second Inks) | | | | | | | | | | | |

TABLE 6

| | Comparative Example | | | | | | | | | | |
|---|---|---|---|---|---|---|---|---|---|---|---|
| | 1 | 2 | 3 | 4 | 5 | 6 | 7 | 8 | 9 | 10 | 11 |
| Set No. | S19 | S20 | S21 | S22 | S23 | S24 | S25 | S26 | S1 | S1 | S18 |
| Recording System | Sys- | Sys- | Sys- | Sys- | Sys- | Sys- | Sys- | Sys- | Sys- | Sys- | Sys- |
| | tem 3 | tem 3 | tem 3 | tem 3 | tem 3 | tem 3 | tem 3 | tem 3 | tem 2 | tem 5 | tem 2 |
| Time from landing of ink to first | 0.25 | 0.25 | 0.25 | 0.25 | 0.25 | 0.25 | 0.25 | 0.25 | 1.5 | 1.5 | 1.5 |
| exposure to radiation (sec) | | | | | | | | | | | |
| Irradiation energy of the | 200 | 200 | 200 | 200 | 200 | 200 | 200 | 200 | 200 | 200 | 200 |
| exposure above (mJ/cm²) | | | | | | | | | | | |
| Irradiation peak intensity of the | 2000 | 2000 | 2000 | 2000 | 2000 | 2000 | 2000 | 2000 | 2000 | 2000 | 2000 |
| exposure above (mW/cm²) | | | | | | | | | | | |
| Color Reproduction Range | D | D | D | D | D | D | D | D | A | A | C |
| Image Quality (Bleed) | B | B | B | B | B | B | B | B | D | D | D |
| Image Quality (Glossiness) | C | C | C | C | C | C | C | C | A | A | A |
| Ejection Stability (First and | B | B | B | B | B | B | B | B | A | A | A |
| Second Inks) | | | | | | | | | | | |

TABLE 7

| | Bk | C | Y | M |
|---|---|---|---|---|
| Diethylene glycol ethyl methyl ether | 54.4 | 53.4 | 54.4 | 54.4 |
| Diethylene glycol diethyl ether | 30 | 30 | 30 | 30 |
| γ-butyrolactone | 10 | 10 | 10 | 10 |
| BYK-340 | 0.1 | 0.1 | 0.1 | 0.1 |
| SOLBIN CL | 2 | 2 | 2 | 2 |
| Carbon Black | 2 | | | |
| Pigment Blue 15:3 | | 2.5 | | |
| Pigment Yellow 155 | | | 2 | |
| Pigment Red 122 | | | | 2 |
| Dispersing Agent | 1.5 | 2 | 1.5 | 1.5 |
| Sum | 100 | 100 | 100 | 100 |

As shown above, it was found that the color reproduction range was narrower in Comparative Examples 1 to 8 in which only one of the first composition and the second composition was used. Further, it was found that bleed occurred and the image quality of the obtained recorded product was degraded in Comparative Examples 9 to 11 in which the step of performing curing by exposing each composition to radiation within 1 second after landing was not performed.

In contrast, in Examples in which both of the first composition and the second composition were used and the step of performing curing by exposing each composition to radiation within 1 second after landing was performed, the color reproduction range and suppression of the bleed were balanced. In addition, as in Examples 1 to 16, the color reproduction range was widened by the combination of the first composition and the second composition, and the color reproduction range was widened further by also using other color compositions as in Example 17. Further, the glossy feel was also imparted by using a clear ink as in Example 18. Moreover, it was found that the color reproduction range, the ejection stability, and the glossiness were further improved by adjusting the irradiation energy or the irradiation peak intensity and performing preliminary curing by weak irradiation as in Examples 25 and 26. In addition, it can be seen that the present disclosure was also effective in Examples 27 to 29, which are examples of line printers.

To be noted, the same evaluation as the evaluation of color reproduction range described above was made by using the solvent-based ink set shown in Table 7. The evaluation pattern was generated by attaching ink to the same recording medium by using the same recording apparatus as that used in Recording System 1. However, while attaching the ink, the surface temperature of the recording medium was heated to 40° C. by using a platen heater. After completion of attachment of ink, the recording medium was discharged from the recording apparatus, heated at 50° C. for 30 minutes, and then left to stand for 1 day at a normal temperature. No exposure to radiation was performed. The evaluation pattern generated in this manner was subjected to color measurement in the same manner as described above. This ink set was similar to an ink set S19 shown above in that the ink set did not include an ink corresponding to the second ink. However, the result concerning the color reproduction range thereof was C. The composition was not a radiation-curable composition, which is used by being cured by exposure to radiation. From this, it was found that the present disclosure is needed to achieve an excellent color reproduction range in the case of using a radiation-curable composition.

What is claimed is:

1. An ink jet method comprising:
ejecting a first composition from an ink jet head, the first composition being a radiation-curable composition having a hue angle of −50° to −5°;
ejecting a second composition from an ink jet head, the second composition being a radiation-curable composition having a hue angle of 5° to 50°; and
curing the ejected first composition and the ejected second composition by exposing the ejected first composition to radiation before 1 second elapses after landing of the ejected first composition and exposing the ejected second composition to radiation before 1 second elapses after landing of the ejected second composition.

2. The ink jet method according to claim 1, further comprising:
ejecting a radiation-curable cyan composition from an ink jet head; and
ejecting a radiation-curable yellow composition from an ink jet head.

3. The ink jet method according to claim 1, wherein a difference between the hue angle of the first composition and the hue angle of the second composition is 10° to 35°.

4. The ink jet method according to claim 1, wherein the hue angle of the first composition is −30° to −10° and the hue angle of the second composition is 10° to 40°.

5. The ink jet method according to claim 1, wherein
the first composition contains, as a pigment, one or more selected from the group consisting of P.R. 31, 122, 202, 207, 209, 147, and 269, and P.V. 32 and 19, and
the second composition contains, as a pigment, one or more selected from the group consisting of P.R. 166, 168, 149, 177, 179, 254, 255, 264, 242, and 224.

6. The ink jet method according to claim 2, further comprising ejecting a third composition from an ink jet head, the third composition being a radiation-curable composition having a hue angle larger than the hue angle of the second composition and smaller than a hue angle of the yellow composition.

7. The ink jet method according to claim 1, wherein irradiation energy of radiation exposure in the curing is 5 mJ/cm² to 2000 mJ/cm².

8. The ink jet method according to claim 1, wherein irradiation peak intensity of radiation exposure in the curing is 150 mW/cm² or more.

9. The ink jet method according to claim 1, wherein an LED is used as a radiation source for radiation exposure in the curing.

10. The ink jet method according to claim 1, further comprising, after the curing, further exposing each composition to radiation after elapse of 1 second after landing of each composition.

11. The ink jet method according to claim 1, wherein the first composition and the second composition contain 2-(2-vinyloxyethoxy)ethyl acrylate.

12. The ink jet method according to claim 1, wherein a content of pigment in the first composition is 2% by mass or less with respect to a total amount of the first composition, and a content of pigment in the second composition is 2% by mass or less with respect to a total amount of the second composition.

13. The ink jet method according to claim 1, further comprising ejecting a radiation-curable clear composition from an ink jet head.

14. An ink jet apparatus that performs the ink jet method according to claim 1 and comprises an ink jet head and a radiation source.
